(19) United States
(12) Patent Application Publication
(10) Pub. No.: US 2012/0086285 A1
(43) Pub. Date: Apr. 12, 2012

(54) APPARATUS FOR HARVESTING ENERGY FROM ELECTROMAGNETIC FIELD

(75) Inventors: Chang Hee HYOUNG, Daejeon (KR); Sung Weon Kang, Daejeon (KR); Tae Young Kang, Seoul (KR); Jung Hwan Hwang, Daejeon (KR); In Gi Lim, Daejeon (KR); Hyung-Il Park, Daejeon (KR); Tae Wook Kang, Daejeon (KR); Kyungsoo Kim, Daejeon (KR); Jung Bum Kim, Daejeon (KR); Sung Eun Kim, Seoul (KR); Kyung Hwan Park, Daejeon (KR); Byoung Gun Choi, Daejeon (KR); Jin Kyung Kim, Daejeon (KR)

(73) Assignee: Electronics and Telecommunications Research Institute, Daejeon (KR)

(21) Appl. No.: 13/269,524

(22) Filed: Oct. 7, 2011

(30) Foreign Application Priority Data
Oct. 8, 2010 (KR) 10-2010-0098265
Sep. 29, 2011 (KR) 10-2011-0098953

(51) Int. Cl. H02J 17/00

(52) U.S. Cl. 307/104

(57) ABSTRACT

An apparatus for harvesting energy from an electromagnetic field include an interface unit and a rectifier circuit. The interface unit obtains signals induced in a human body in electronic devices. The rectifier circuit rectifies an AC signal inputted from the interface unit and converts the inputted AC signal into DC power. Accordingly, it is possible to obtain desired power without additional exposure of an electromagnetic field to a human body or surroundings of the human body.

### CROSS-REFERENCES TO RELATED APPLICATIONS

The present application claims priority under 35 U.S.C 119(a) to Korean Application No. 10-2010-0098265, filed on Oct. 8, 2010 and Korean Application No. 10-2011-0098953, filed on Sep. 29, 2011, in the Korean Intellectual Property Office, which is incorporated herein by reference in its entirety set forth in full.

### BACKGROUND

Exemplary embodiments of the present invention relate to an apparatus for harvesting energy from an electromagnetic field, and more particularly, to an apparatus for harvesting electric energy from a signal induced in a human body.

An energy harvesting field is a field in which energy is harvested from ambient environment. Energy harvesting is a technology for converting ambient energy into electric energy available for an operation of a circuit.

The energy harvesting can be used in simple and cheap communications by being applied to wireless personal area networks (WPAN) and radio-frequency identification (RFID), which allow circuits to operate without batteries or without additional charging of batteries. Accordingly, its applications extend over considerably wide ranges.

Further, the energy harvesting is a future-oriented industry that allows energy to be efficiently used for all personal communications so that a clean natural environment can be handed down to descendants.

A method of harvesting energy from sunlight with existing solar cells is most frequently known as an energy harvesting method. However, the method is not suitable for the RFID and WPAN and has a limitation in harvesting electric energy for driving a small transceiver circuit due to a large area required to be applied to the transceiver circuit.

Accordingly, studies for harvesting energy using various methods have been conducted in all over the world. Among these studies, representative studies have been conducted to develop a method of harvesting energy through vibration, a method of harvesting energy through a difference in temperature, a method of harvesting energy by receiving RF signals through an antenna with a millimeter (mm) size.

The background art has been disclosed in Korean Patent Laid-Open Publication No. 10-2011-0066645 (Jun. 6, 2011).

### SUMMARY

An embodiment of the present invention relates to an apparatus for harvesting energy from an electromagnetic field, which harvests energy from the electromagnetic field induced in a human body from various electronic devices existing around a user, so that the user can obtain energy while leading an active life without restricting the user's activity.

Another embodiment of the present invention relates to an apparatus for harvesting energy from an electromagnetic field, which can obtain power without using a resonance means, unlike a conventional method for harvesting energy by receiving electromagnetic waves through a human body, in which power is converted using the resonance means in resonant with a specific frequency of various broadcasting waves in a band of a few tens of MHz, in which the human body is available as an antenna.

In one embodiment, an apparatus for harvesting energy from an electromagnetic field includes an interface unit configured to obtain signals induced in a human body from electronic devices; and a rectifier circuit configured to rectify an AC signal inputted from the interface unit and convert the rectified AC signal into DC power.

The interface unit may be formed using a conductive material including a metal, a flexible substrate and a conductive fiber, or a conductive gel such as an ECG electrode.

The apparatus may further include a filter provided at a front end of the rectifier circuit so as to filter the signal inputted from the interface unit.

The filter may include at least one of a low-pass filter, a band-pass filter and a high-pass filter.

The interface unit may be provided with interface units respectively corresponding to frequency bands of the signals induced in the human body.

The rectifier circuit may be provided with rectifier circuits respectively corresponding to the frequency bands of the signals induced in the human body.

In another embodiment, an apparatus for harvesting energy from an electromagnetic field includes an antenna unit configured to receive an electromagnetic field generated from electronic devices, an interface unit configured to obtain signals induced in the antenna unit, and a rectifier circuit configured to rectify an AC signal inputted from the interface unit and convert the rectified AC signal into DC power.

The antenna unit may be formed using a conductive material.

The interface unit may be formed using a conductive material including a metal, a flexible substrate and a conductive fiber, or a conductive gel such as an ECG electrode.

The apparatus may further include a filter provided at a front end of the rectifier circuit so as to filter the signal inputted from the interface unit.

The filter may include at least one of a low-pass filter, a band-pass filter and a high-pass filter.

The interface unit may be provided with interface units respectively corresponding to frequency bands of the signals induced in the antenna unit.

The rectifier circuit may be provided with rectifier circuits respectively corresponding to the frequency bands of the signals induced in the antenna unit.

### BRIEF DESCRIPTION OF THE DRAWINGS

The above and other aspects, features and other advantages will be more clearly understood from the following detailed description taken in conjunction with the accompanying drawings, in which:

FIG. 1 is a block diagram illustrating a configuration of an apparatus for harvesting energy from an electromagnetic field according an embodiment of the present invention;

FIG. 2 illustrates an environment of an electromagnetic field induced in a human body from electronic devices;

FIG. 3 is a block diagram illustrating a configuration of an apparatus for harvesting energy from an electromagnetic field according another embodiment of the present invention;

FIG. 4 is a block diagram illustrating a configuration of an apparatus for harvesting energy from an electromagnetic field according another embodiment of the present invention; and

FIG. 5 is a block diagram illustrating a configuration of an apparatus for harvesting energy from an electromagnetic field according another embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

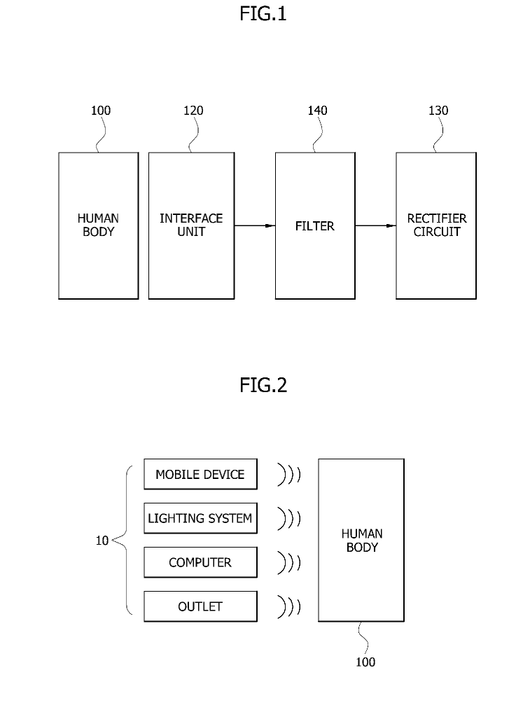

FIG. 1 is a block diagram illustrating a configuration of an apparatus for harvesting energy from an electromagnetic field according an embodiment of the present invention. FIG. 2 illustrates an environment of an electromagnetic field induced in a human body from electronic devices.

The apparatus according to this embodiment generates power from energy of a low-frequency electromagnetic field induced in a human body 100. The apparatus harvests energy from an electromagnetic field induced in the human body 100 in various electronic devices 10 that exist around a user.

To this end, as illustrated in FIG. 1, the apparatus includes an interface unit 120 for obtaining a signal induced in the human body 100, a rectifier circuit 130 of rectifying an AC signal inputted from the interface unit 120 and converting the inputted AC signal into DC power, and a filter 140 provided at a front end of the rectifier circuit 130 so as to filter a signal inputted from the interface unit 120.

The human body 100 has very high permittivity in a low frequency band. Therefore, a larger amount of power is induced in the human body 100 in a low frequency.

FIG. 2 illustrates an environment of an electromagnetic field induced in the human body 100 from the various electronic devices 10, e.g., a mobile device, a lighting system, a computer, an outlet and the like.

As illustrated in this figure, unlike a conventional apparatus for harvesting energy using RF, the apparatus according to this embodiment contacts or approaches the human body 100 using a material with conductivity and receives a signal from the human body 100, thereby harvesting energy.

The interface unit 120 is disposed at a position contacting or approaching the human body 100 so as to obtain signals induced in the human body 100 from the electronic devices 10.

The interface unit 120 is not restricted by a physical size for receiving signals in a desired band.

The interface unit 120 is formed using a material with conductivity. The material with conductivity may be not only a metal but also a flexible substrate or conductive fiber that can reduce the feeling of rejection, caused by a user's action or contact. The material with conductivity may also include the form of a conductive gel such as an ECG electrode. In addition to the material with conductivity, the interface unit 120 may be formed in a shape for better receiving an electric signal from the human body in which the electromagnetic waves are induced.

An AC signal inputted from the interface unit 120 is converted into DC power via the rectifier circuit 130.

The rectifier circuit 130 rectifies the AC signal inputted from the interface unit 120 and generates the DC power. The rectifier circuit 130 operates by receiving an AC signal with a certain period. To this end, the filter 140 for filtering a signal inputted from the interface unit 120 is provided at a front end of the rectifier circuit 130. The filter 140 may include a band-pass filter, a low-pass filter, a high-pass filter and the like.

That is, the filter 140 provided at the front end of the rectifier circuit 130 is used to efficiently rectify the signal inputted from the interface unit 120. In place of a resonance means for resonating a signal with a frequency of broadcasting waves, the filter 140 is used to obtain a signal of a predetermined period necessary for rectification.

The electromagnetic waves induced in the human body 100 may exist in several bands. In a case where the filter 140 is not used, the efficiency of rectification may be lowered due to destructive interference or the like.

Only a configuration of the low-pass filter may be used to obtain power from a signal of 60 Hz, outputted from a fluorescent lamp having a magnetic ballast or a line power to supply AC electric power with 60 Hz.

A very large-sized inductor and a capacitor are required to implement a conventional resonance means in a band of 60 Hz. Particularly, the inductor occupies a large volume in the resonance means, and the cost of the inductor is greater than that of a resistor or capacitor.

The low-pass filter may be implemented using only a resistor and a capacitor.

A configuration of the band-pass filter is required to obtain power from a signal in a band of a few tens of kHz, outputted from a fluorescent lamp having an electronic ballast.

In a case power from a signal in a band above a few tens of kHz outputted from a fluorescent lamp is smaller than or does not correspond to that from the signal in the band of a few tens of kHz, the filter 140 may be configured using only the high-pass filter. In this case, the filter 140 is configured using passive elements that do not require power as elements necessary for energy harvesting. The passive elements may be replaced with other elements that perform the same function.

Currently used fluorescent lamps are generally classified into a fluorescent lamp driven using a magnetic ballast and a fluorescent lamp driven using an electronic ballast, and are gradually changed from the fluorescent lamp driven using the magnetic ballast to the fluorescent lamp driven using the electronic ballast. In consideration of this, the filter may be configured to obtain power by dividing the electromagnetic waves induced in the human body into an electromagnetic wave in the band of 60 Hz, outputted from the fluorescent lamp using the power line and the magnetic ballast, and an electromagnetic wave in the band of a few tens of kHz, outputted from the fluorescent lamp using the electronic ballast.

Meanwhile, since current CMOS technologies are downscaled to 45 to 65 nm, the driving voltage required in circuits is lowered down to 0.8 V or less, and the power consumption required in circuits is considerably decreased. Thus, wireless sensor networks can be built up even using minimum driving power of a unit of μW or less.

However, voltage obtained by the energy harvesting is restricted in obtaining a voltage at which general circuits can be driven. Therefore, the voltage is necessarily increased so as to obtain a required voltage. In this case, a DC/DC converter circuit (not shown) may be additionally used.

Meanwhile, signals in various frequency bands may be induced in the human body 100. Accordingly, the structures of the interface unit 120 and the rectifier circuit 130 can be improved according to each of the frequency bands induced in the human body 100.

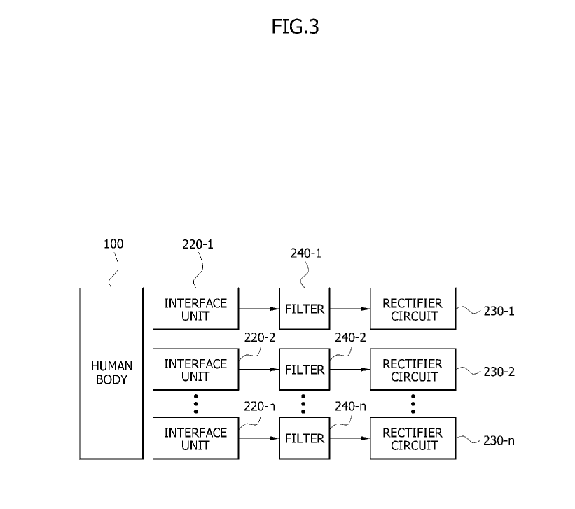

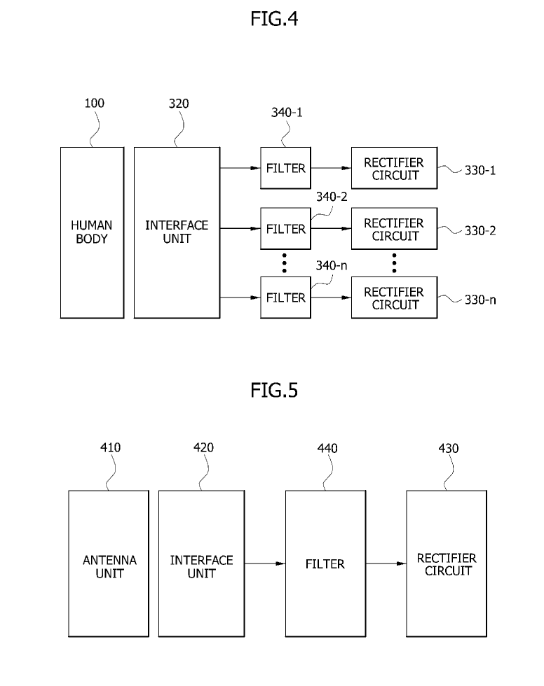

This will be described with reference to FIGS. 3 and 4.

FIG. 3 is a block diagram illustrating a configuration of an apparatus for harvesting energy from an electromagnetic field according another embodiment of the present invention.

As illustrated in FIG. 3, in the apparatus according to this embodiment, a plurality of interface units 220-1, 220-2, . . . , 220-n for obtaining signals induced in the human body 100, which are provided to corresponding to frequency bands, respectively, and a plurality of rectifier circuits 230-1, 230-2, . . . , 230-n for rectifying signals in the frequency bands, which are provided to correspond to the interface units 220-1, 220-2, . . . , 220-n, respectively. The apparatus further includes filters 240-1, 240-2, . . . , 240-n respectively provided corresponding to the rectifier circuits 230-1, 230-2, . . . , 230-n so as to filter signals inputted from the interface units 220-1, 220-2, . . . , 220-n. The filters 240-1, 240-2, . . . , 240-n may be identically applied to the embodiment illustrated in FIG. 1.

That is, the apparatus according to this embodiment includes the plurality of interface units 220-1, 220-2, . . . , 220-n and the plurality of rectifier circuits 230-1, 230-2, . . . , 230-n, corresponding to the respective frequency bands of the signals induced in the human body 100. Thus, the apparatus can simultaneously harvest energy from the signals in the various frequency bands induced in the human body 100.

FIG. 4 is a block diagram illustrating a configuration of an apparatus for harvesting energy from an electromagnetic field according another embodiment of the present invention.

As illustrated in FIG. 5, the apparatus according to this embodiment includes one interface unit 320 for obtaining signals induced in the human body 100 and a plurality of rectifier circuits 330-1, 330-2, . . . , 330-n respectively corresponding to frequency bands of the signals induced in the human body 100. The apparatus further includes filters 340-1, 340-2, . . . , 340-n respectively provided corresponding to the rectifier circuits 330-1, 330-2, . . . , 330-n so as to filter signals inputted from one interface unit 320. The filters 340-1, 340-2, . . . , 340-n may be identically applied to the embodiment illustrated in FIG. 1.

The obtaining of the signals in the various frequency bands through the one interface unit 320 is because the interface unit 320 does not depend on frequencies.

As described above, the apparatus according to this embodiment can obtain the signals in the various frequency bands through the one interface unit 320.

Meanwhile, although it has been illustrated in the aforementioned embodiments that the apparatus harvests energy from an electromagnetic field received through the human body 100 serving as an antenna, the apparatus may harvest energy using a conductive material capable of serving as an antenna, in place of the human body 100. This will be described with reference to FIG. 5.

FIG. 5 is a block diagram illustrating a configuration of an apparatus for harvesting energy from an electromagnetic field according another embodiment of the present invention.

The apparatus according to this embodiment includes an antenna unit 410 for receiving an electromagnetic field generated from the electronic devices 10, an interface unit 420 for obtaining signals induced in the antenna unit 410, and a rectifier circuit 430 for rectifying an AC signal inputted from the interface unit 420 and outputting a DC signal. The apparatus may further includes a filter 440 provided corresponding to the rectifier circuit 430 so as to filter a signal inputted from the interface unit 420. The filter 430 may be identically applied to the embodiment illustrated in FIG. 1.

The antenna unit 410 may be formed using a conductive material. For example, the antenna unit 410 may be applied to clothes having a conductive fiber. The clothes having the conductive fiber use the conductive fiber as an antenna, and energy can be harvested from an electromagnetic field inputted to the antenna in place of the human body 100. The technique for obtaining a electromagnetic field from an antenna unit not from a human body and energy harvesting technique using that are widely applied in a band of RF. The present embodiment relates to a technique for obtaining the signal in the band described above not in the band of RF from an antenna not from a human body. Due to a lower frequency than RF, it is difficult to configure an antenna suitable for a corresponding wavelength and is required sufficient space. However, in case of the present embodiment, an antenna is formed using conductive fibers in clothes and it is possible to obtain power through the clothes by further using a loop antenna of RFID used in a band of 13.56 MHz for a frequency range in a band of a few tens of kHz. The above antenna may be designed corresponding to a frequency band of energy to obtain. Despite a lower gain than the antenna, considering a size of an object, another structure may be used in order to obtain more electric field. This may be realized to be incorporated with a conductive interface.

An implantable device requires an antenna with a very small size. In a case where a radio scheme is used, the implantable device requires an antenna with a considerable large size.

On the other hand, since the apparatus according to this embodiment does not require an antenna, a space required by the apparatus is very small, and thus the apparatus can be used as an auxiliary power source.

For example, the apparatus may be applied as an auxiliary means of an existing battery in a device such as a hearing aid, which directly contacts the human body 100.

Here, the interface unit 420, the rectifier circuit 430 and the filter 440 are identical to those of the aforementioned embodiments, and therefore, their detailed descriptions will be omitted.

As described above, the apparatus according to the present does not require an energy source for providing energy, and can obtain desired power without additional exposure of an electromagnetic field to a human body or surroundings of the human body.

Since the apparatus according to the present invention does not require an antenna for receiving an electromagnetic field from the outside, the apparatus can generate desired power even in a small area. Since the apparatus according to the present invention does not require the antenna, the apparatus can simultaneously use signals in various frequency bands, induced in the human body.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. An apparatus for harvesting energy from an electromagnetic field, the apparatus comprising:
an interface unit configured to obtain signals induced in a human body from electronic devices; and
a rectifier circuit configured to rectify an AC signal inputted from the interface unit and convert the rectified AC signal into DC power.

2. The apparatus of claim 1, wherein the interface unit is formed using a conductive material including a metal, a flexible substrate and a conductive fiber, or a conductive gel such as an ECG electrode.

3. The apparatus of claim 1, further comprising a filter provided at a front end of the rectifier circuit to filter the signal inputted from the interface unit.

4. The apparatus of claim 3, wherein the filter comprises at least one of a low-pass filter, a band-pass filter and a high-pass filter.

5. The apparatus of claim 1, wherein the interface unit is provided with interface units respectively corresponding to frequency bands of the signals induced in the human body.

6. The apparatus of claim 1, wherein the rectifier circuit is provided with rectifier circuits respectively corresponding to the frequency bands of the signals induced in the human body.

7. An apparatus for harvesting energy from an electromagnetic field, the apparatus comprising:
an antenna unit configured to receive an electromagnetic field generated from electronic devices;
an interface unit configured to obtain signals induced in the antenna unit; and
a rectifier circuit configured to rectify an AC signal inputted from the interface unit and convert the rectified AC signal into DC power.

8. The apparatus of claim 7, wherein the antenna unit is formed using a conductive material.

9. The apparatus of claim 7, wherein the interface unit is formed using a conductive material including a metal, a flexible substrate and a conductive fiber, or a conductive gel such as an ECG electrode.

10. The apparatus of claim 7, further comprising a filter provided at a front end of the rectifier circuit to filter the signal inputted from the interface unit.

11. The apparatus of claim 10, wherein the filter comprises at least one of a low-pass filter, a band-pass filter and a high-pass filter.

12. The apparatus of claim 7, wherein the interface unit is provided with interface units respectively corresponding to frequency bands of the signals induced in the antenna unit.

13. The apparatus of claim 7, wherein the rectifier circuit is provided with rectifier circuits respectively corresponding to the frequency bands of the signals induced in the antenna unit.

14. The apparatus of claim 7, wherein the antenna unit is formed by clothes having conductive fibers.
